(19) United States
(12) Patent Application Publication
(10) Pub. No.: US 2026/0211447 A1
(43) Pub. Date: Jul. 23, 2026

(54) NON-TRANSITORY COMPUTER-READABLE RECORDING MEDIUM, INFORMATION PROCESSING DEVICE, AND INFORMATION PROCESSING METHOD

(71) Applicant: Fujitsu Limited, Kawasaki-shi (JP)

(72) Inventor: Takashi ISHIZUKA, Kawasaki (JP)

(73) Assignee: Fujitsu Limited, Kawasaki-shi (JP)

(21) Appl. No.: 19/369,450

(22) Filed: Oct. 27, 2025

(30) Foreign Application Priority Data
Oct. 28, 2024 (JP) 2024-188748

(51) Int. Cl. G06F 1/02; G06F 16/28

(52) U.S. Cl. CPC G06F 1/02; G06F 16/288

(57) ABSTRACT

A non-transitory computer-readable recording medium stores therein a program that causes a computer to execute a process including acquiring causal information representing a causal relationship among a plurality of variables, information representing a particular objective variable out of the variables, and information representing an intervention variable to be set out of the variables, generating a particular function representing a relationship between the particular objective variable and the intervention variable, based on the causal information, deciding, based on an objective function including the particular function, a value of the intervention variable that improves a value of the objective function, and outputting the value of the intervention variable.

### CROSS-REFERENCE TO RELATED APPLICATION

This application is based upon and claims the benefit of priority of the prior Japanese Patent Application No. 2024-188748, filed on Oct. 28, 2024, the entire contents of which are incorporated herein by reference.

### FIELD

The embodiment discussed herein is related to information processing.

### BACKGROUND

In decision making in business improvement, labor management, marketing, etc., for companies, organizations, etc., it is useful to analyze data related to various factors accumulated in the past.

With respect to interventions in marketing, etc., information processing methods that are expected to support the implementation of appropriate interventions are known (see, for example, Japanese Patent No. 7326640).

### SUMMARY

According to an aspect of an embodiment, a non-transitory computer-readable recording medium stores therein a program that causes a computer to execute a process including acquiring causal information representing a causal relationship among a plurality of variables, information representing a particular objective variable out of the variables, and information representing an intervention variable to be set out of the variables, generating a particular function representing a relationship between the particular objective variable and the intervention variable, based on the causal information, deciding, based on an objective function including the particular function, a value of the intervention variable that improves a value of the objective function, and outputting the value of the intervention variable.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram expressing a correlation in a first comparative example;

FIG. 2 is a diagram expressing a causal graph in a second comparative example;

FIG. 3 is a functional configuration diagram of an information processing device according to an embodiment;

FIG. 4 is a flowchart of information processing;

FIG. 5 is a configuration diagram of an action support system;

FIG. 6 is a functional configuration diagram of an action support device;

FIG. 7 is a diagram expressing a first causal graph;

FIG. 8 is a diagram expressing a second causal graph;

FIG. 9 is a flowchart of an action support process; and

FIG. 10 is a hardware configuration diagram of the information processing device.

### DESCRIPTION OF EMBODIMENTS

In business improvement, labor management, marketing, etc. for companies, organizations, etc., it is difficult to utilize data accumulated in the past to propose appropriate actions to achieve their objectives.

This problem arises not only when proposing actions for business improvement, labor management, marketing, etc., but also when proposing actions for various problems.

Preferred embodiments will be explained with reference to accompanying drawings.

First, first and second comparative examples are explained as methods for proposing actions for a problem described with a plurality of variables.

In the first comparative example, by referring to the data of each variable without considering a causal relationship among the variables, an explanatory variable with the greatest correlation to a value of an objective function is selected and an intervention to change a value of that explanatory variable is proposed as an action.

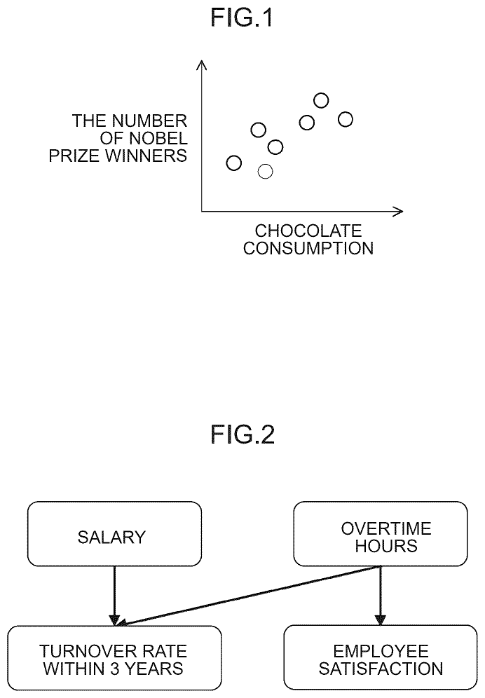

FIG. 1 illustrates an example of a correlation in the first comparative example. The horizontal axis represents chocolate consumption and the vertical axis represents the number of Nobel Prize winners. The chocolate consumption is the explanatory variable and the number of Nobel Prize winners is the objective variable. In this case, there is a correlation between the number of Nobel Prize winners and the chocolate consumption, but there is no causal relationship. Thus, the intervention to change the chocolate consumption does not always maximize the number of Nobel Prize winners.

Thus, even if the action proposed by the first comparative example is adopted, whether the value of the objective function will be maximized is not known because the causal relationship is not taken into account.

In the second comparative example, the explanatory variable that has a direct influence on the objective variable is selected by considering the causal relationship among the variables, and an intervention to change the value of that explanatory variable is proposed as the action.

FIG. 2 illustrates an example of a causal graph in the second comparative example. The causal graph in FIG. 2 expresses the causal relationship among the variables used in labor management in a company and includes nodes representing salary, overtime hours, a turnover rate within 3 years, and employee satisfaction. The arrow between the two nodes represents an edge directed from the node representing the cause to the node representing the effect.

For example, in the causal relationship between the salary and the turnover rate within 3 years, the salary represents the cause and the turnover rate within 3 years represents the effect. In the causal relationship between the overtime hours and the turnover rate within 3 years, the overtime hours represent the cause and the turnover rate within 3 years represents the effect. In the causal relationship between the overtime hours and the employee satisfaction, the overtime hours represent the cause and the employee satisfaction represents the effect.

As an example, it is assumed that you wish to minimize the turnover rate within 3 years without changing the employee satisfaction. In this case, the objective variable is the turnover rate within 3 years. Therefore, the salary and the overtime hours, which have a direct influence on the turnover rate within 3 years, are selected as the variables to be intervened. However, the intervention to change the overtime hours would change the employee satisfaction as well as the turnover rate within 3 years.

Thus, adopting the action proposed by the second comparative example may achieve the objective because the causal relationship is taken into account, but this may also affect other variables that you do not want to change.

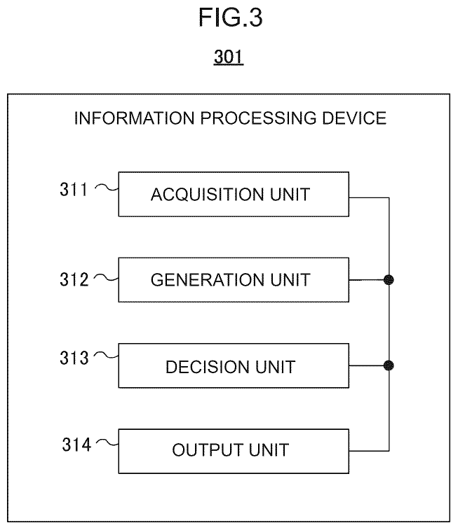

FIG. 3 illustrates a functional configuration example of an information processing device (computer) according to the embodiment. An information processing device 301 in FIG. 3 includes an acquisition unit 311, a generation unit 312, a decision unit 313, and an output unit 314.

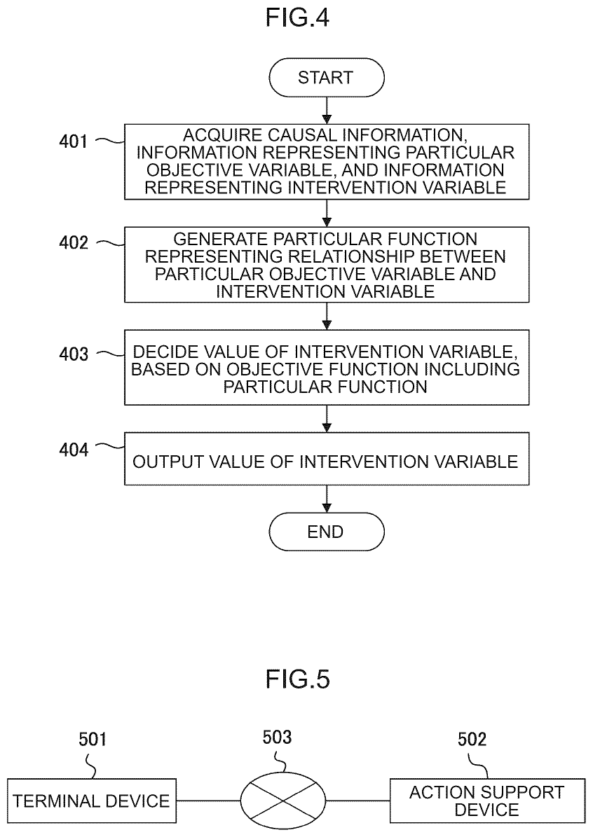

FIG. 4 is a flowchart illustrating an example of information processing performed by the information processing device 301 in FIG. 3. First, the acquisition unit 311 acquires causal information representing the causal relationship among the variables, information representing a particular objective variable out of the variables, and information representing an intervention variable to be set out of the variables (step 401).

Next, the generation unit 312 generates a particular function that represents the relationship between the particular objective variable and the intervention variable on the basis of the causal information (step 402). Subsequently, the decision unit 313 decides a value of the intervention variable that improves the value of the objective function on the basis of the objective function including the particular function (step 403). The output unit 314 then outputs the value of the intervention variable (step 404).

According to the information processing device 301 in FIG. 3, the value of the variable to be set out of the variables describing the problem can be effectively decided.

FIG. 5 illustrates a configuration example of an action support system including the information processing device 301 in FIG. 3. The action support system illustrated in FIG. 5 includes a terminal device 501 and an action support device 502. The action support device 502 corresponds to the information processing device 301 in FIG. 3.

The terminal device 501 and the action support device 502 can communicate with each other via a communication network 503. The communication network 503 is, for example, a local area network (LAN) or a wide area network (WAN).

The terminal device 501 is an information processing device of a user. The user inputs the causal information representing the causal relationship among the variables included in a desired problem and input information specifying the problem to the terminal device 501 via a user interface. The desired problem may be a problem related to decision making in business improvement, labor management, marketing, etc. for a company, an organization, etc. The terminal device 501 transmits the input causal information and input information to the action support device 502.

The action support device 502 uses the received causal information and input information to perform an action support process to decide the value of the intervention variable. The intervention variables are variables that represent actions to achieve the objectives of the problem. The action support device 502 transmits the decided value of the intervention variable to the terminal device 501 as a result of the process.

The terminal device 501 displays the received value of the intervention variable on a screen as the action proposed by the action support device 502. The user can accomplish the objective by executing the displayed action.

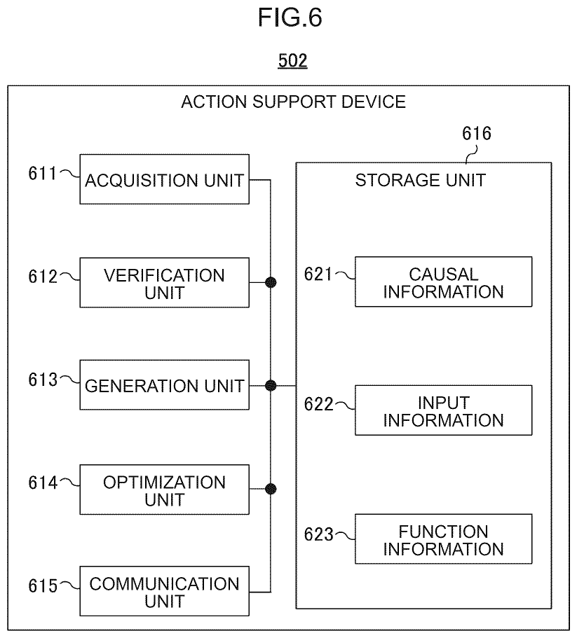

FIG. 6 illustrates a functional configuration example of the action support device 502 in FIG. 5. The action support device 502 in FIG. 6 includes an acquisition unit 611, a verification unit 612, a generation unit 613, an optimization unit 614, a communication unit 615, and a storage unit 616. The acquisition unit 611, the generation unit 613, the optimization unit 614, and the communication unit 615 correspond to the acquisition unit 311, the generation unit 312, the decision unit 313, and the output unit 314 in FIG. 3, respectively.

The communication unit 615 communicates with the terminal device 501 via the communication network 503. The acquisition unit 611 acquires the causal information and the input information by receiving the causal information and the input information from the terminal device 501 via the communication unit 615. The acquisition unit 611 stores the received causal information in the storage unit 616 as causal information 621 and stores the received input information in the storage unit 616 as input information 622.

The causal information 621 is, for example, a structural causal model, which includes information on the variable represented by each of N (N is an integer greater than or equal to 2) nodes included in the causal graph. The information on each variable includes a variable name x(i) (i=1 to N), a variable name of a parent variable, a probability density function of a noise for the value of the variable x(i), and a structural equation.

The parent variable is the variable that corresponds to the in-neighbor of the node representing the variable x(i) in the causal graph. The in-neighbor represents a starting point of a directed edge connected to the node representing the variable x(i). Thus, the in-neighbor represents the cause, and the node representing the variable x(i) represents the effect. More than one parent variable may exist, or the parent variable does not exist in some cases.

The structural equation is an equation expressing a data generation process that generates the value of the variable x(i), and is described using the parent variable and the noise. In this case, the variable x(i) corresponds to the objective variable and the parent variable corresponds to the explanatory variable. The structural equation may be either a linear equation or a nonlinear equation. The information on the N variables included in the causal information 621 may be information in a table form.

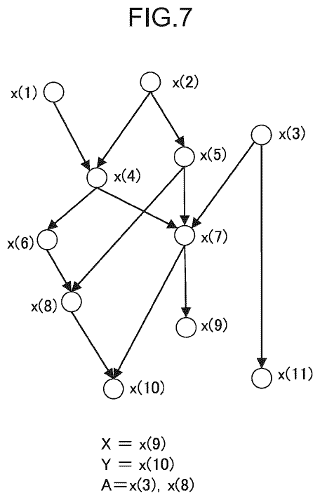

FIG. 7 illustrates an example of a first causal graph represented by the causal information 621. The causal graph in FIG. 7 includes nodes representing the variables x(1) to x(11). The arrow between the two nodes represents an edge directed from the node representing the cause to the node representing the effect. In this example, N=11.

In the case of labor management, the respective variables x(i) (i=1 to 11) represent, for example, overtime hours, salary, psychological reward, comfort of a work environment, work-life balance, the rank of a job position, the level of discretion, etc.

For example, in the causal relationship between the variables x(1) and x(4), the variable x(1) represents the cause and the variable x(4) represents the effect. In the causal relationship between the variables x(2) and x(4), the variable x(2) represents the cause and the variable x(4) represents the effect. In the causal relationship between the variables x(2) and x(5), the variable x(2) represents the cause and the variable x(5) represents the effect.

The parent variable of the variable x(9) is the variable x(7), and the parent variable of the variable x(7) is the variables x(3) to x(5). The parent variable of the variable x(4) is the variables x(1) and x(2) and the parent variable of the variable x(5) is the variable x(2). There is no parent variable for the variables x(1) to x(3). The structural equations for the variables x(1) to x(11) are expressed as follows.

$$x ( 1 ) = f 1 ( ε ( 1 ) )$$

$$x ( 2 ) = f 2 ( ε ( 2 ) )$$

$$x ( 3 ) = f 3 ( ε ( 3 ) )$$

$$x ( 4 ) = f 4 ( x ( 1 ) , x ( 2 ) ; ( ε ( 4 ) )$$

$$x ( 5 ) = f 5 ( x ( 2 ) , ( ε ( 5 ) )$$

$$x ( 6 ) = f 6 ( x ( 4 ) , ( ε ( 6 ) )$$

$$x ( 7 ) = f 7 ( x ( 3 ) , x ( 4 ) , x ( 5 ) ; ( ε ( 7 ) )$$

$$x ( 8 ) = f 8 ( x ( 5 ) , x ( 6 ) ; ( ε ( 8 ) )$$

$$x ( 9 ) = f 9 ( x ( 7 ) ; ( ε ( 9 ) )$$

$$x ( 10 ) = f 10 ( x ( 7 ) , x ( 8 ) ; ( ε ( 10 ) )$$

$$x ( 11 ) = f 11 ( x ( 3 ) ; ( ε ( 11 ) )$$

ε(i) (i=1 to 11) represents the noise for the value of the variable x(i), and f(i) represents the function that generates the value of the variable x(i) from the parent variable and the noise ε(i).

The input information 622 includes variable names representing an objective variable X, a control variable Y, and an intervention variable A among the N variables included in the causal information 621, a target value 0 of the control variable Y, a cost function C of the intervention variable A, and a budget β. The variable name is one example of information representing the variable.

The objective variable X is the particular objective variable to be optimized in the action support process. Optimization of the objective variable X is, for example, maximization or minimization of the objective variable X. The control variable Y is the variable that is controlled to approach the target value 0. The target value 0 is a real number.

The intervention variable A is a variable that the user can intervene. The cost function C is a function that describes the cost associated with the intervention represented by the intervention variable A. The budget β is an upper limit value of the cost associated with the intervention. The cost and budget are real numbers greater than or equal to zero. The intervention variable A is one example of the intervention variable to be set by the user.

The input information 622 may include information representing a plurality of the control variables Y and information representing a plurality of the intervention variables A. In the example in FIG. 7, the variable x(9) is designated as the objective variable X, the variable x(10) is designated as the control variable Y, and the variables x(3) and x(8) are designated as the intervention variables A.

The verification unit 612 verifies the directed acyclicity of the causal graph by determining whether the causal graph represented by the causal information 621 includes a closed path. If the causal graph does not include a closed path, the causal graph is determined to be a directed acyclic graph; if the causal graph includes a closed path, the causal graph is determined to be not a directed acyclic graph.

By verifying the directed acyclicity of the causal graph, an optimization process can be set up to find a solution for the intervention variable A without considering the immovable point constraints that constrain feasible solutions to the immovable point set. This makes it possible to obtain the value of the intervention variable A to achieve the objective for sure.

If it is determined that the causal graph is the directed acyclic graph, the generation unit 613 sets the structural equation of the objective variable X included in the causal information 621 as the equation to be processed. Each parent variable included in the equation to be processed may be connected to any of the intervention variables A by one or more edges in the causal graph. Therefore, the generation unit 613 assigns the structural equation of each parent variable to the corresponding parent variable.

In addition, the generation unit 613 repeats the process of assigning, to each parent variable included in the assigned structural equation, the structural equation of the corresponding parent variable successively until the input of the equation to be processed becomes the intervention variable A and the noise ε. This makes it easy to generate a function FX(A, ε) representing the objective variable X using the intervention variable A and the noise ε as inputs.

The input A of the function FX(A, ε) represents a part or all of the intervention variables A out of all the intervention variables A. The input ε of the function FX(A, ε) represents a part of the noises ε(i) out of all the noises ε(i). Thus, the function FX(A, ε) represents the relationship between the objective variable X and one or more intervention variables A.

By leaving the noise ε in the input of the function FX(A, ε), the stochastic data generation process that generates the value of the objective variable X can be accurately expressed.

The structural equation of the objective variable X is one example of the particular structural equation. Each parent variable included in the equation to be processed is one example of a first variable. The structural equation of each parent variable included in the equation to be processed is one example of a first structural equation. The function FX(A, ε) is one example of the particular function.

For example, the objective variable X in FIG. 7 is the variable x(9), and the intervention variable A is the variables x(3) and x(8). The structural equation of the variable x(9) is expressed by the following equation.

$$x ( 9 ) = f 9 ( x ( 7 ) ; ( ε ( 9 ) ) \qquad ( 1 )$$

The variable x(7) included in Equation (1) is connected to the variable x(3) by the edge. Then, by assigning the structural equation of the variable x(7) to the variable x(7) in Equation (1), the following equation is obtained.

$$x ( 9 ) = f 9 ( f 7 ( x ( 3 ) , x ( 4 ) , x ( 5 ) ; ( ε ( 7 ) ) ; ( ε ( 9 ) ) \qquad ( 2 )$$

The variable x(4) included in Equation (2) is connected to the variables x(1) and x(2) by the edge, and the variable x(5) is connected to the variable x(2) by the edge. Then, by assigning the structural equation of the variable x(4) to the variable x(4) in Equation (2) and assigning the structural equation of the variable x(5) to the variable x(5), the following equation is obtained.

$$x ( 9 ) = f 9 ( f 7 ( x ( 3 ) , f 4 ( x ( 1 ) , x ( 2 ) ; ε ( 4 ) ) , f 5 ( x ( 2 ) ; ε ( 5 ) ) ; ε ( 7 ) ) ; ε ( 9 ) ) \qquad ( 3 )$$

Next, by assigning the structural equation of the variable x(1) to the variable x(1) in Equation (3) and assigning the structural equation of the variable x(2) to the variable x(2), the following equation is obtained.

$$FX ( A , ε ) = x ( 9 ) = \text{} f \text{} \text{} 9 \text{} ( f \text{} 7 \text{} ( x ( 3 ) , \\ f 4 ( f 1 ( ε ( 1 ) ) , f 2 ( ε ( 2 ) ) ; ε ( 4 ) ) , f 5 ( f 2 ( ε ( 2 ) ) ; ε ( 5 ) ) ; ε ( 7 ) ) ; ε ( 9 ) ) \qquad ( 4 )$$

Equation (4) represents the relationship between x(9), which is the objective variable X, and the variable x(3), which is one of the intervention variables A.

Next, the generation unit 613 sets the structural equation of each control variable Y included in the causal information 621 as the equation to be processed. Each parent variable included in the equation to be processed is connected to some intervention variable A by one or more edges in the causal graph. Therefore, the generation unit 613 assigns the structural equation of each parent variable to the corresponding parent variable.

In addition, the generation unit 613 repeats the process of assigning, to each parent variable included in the assigned structural equation, the structural equation of the corresponding parent variable successively until the input of the equation to be processed becomes the intervention variable A and the noise ε. This makes it easy to generate a function FY(A, ε) representing each control variable Y using the intervention variable A and the noise ε as inputs.

The input A of the function FY(A, ε) represents a part or all of the intervention variables A out of all the intervention variables A. The input ε of the function FY(A, ε) represents a part of the noises ε(i) out of all the noises ε(i). Thus, the function FY(A, ε) represents the relationship between each control variable Y and one or more intervention variables A.

By leaving the noise ε in the input of the function FY(A, ε), the stochastic data generation process that generates the value of each control variable Y can be accurately expressed.

The structural equation of each control variable Y is one example of a control structure equation. Each parent variable included in the equation to be processed is one example of a second variable. The structural equation of each parent variable included in the equation to be processed is one example of a second structural equation. The function FY(A, ε) is one example of a control function.

For example, the control variable Y in FIG. 7 is the variable x(10), and the intervention variable A is the variables x(3) and x(8). The structural equation of the variable x(10) is expressed by the following equation.

$$x ( 10 ) = f 10 ( x ( 7 ) , x ( 8 ) ; ε ( 10 ) ) \qquad ( 5 )$$

The variable x(7) included in Equation (5) is connected to the variable x(3) by the edge. Then, by assigning the structural equation of the variable x(7) to the variable x(7) in Equation (1), the following equation is obtained.

$$x ( 10 ) = f 10 ( f 7 ( x ( 3 ) , x ( 4 ) , x ( 5 ) ; ε ( 7 ) ) , x ( 8 ) ; ε ( 10 ) ) \qquad ( 6 )$$

The variable x(4) included in Equation (6) is connected to the variables x(1) and x(2) by the edge, and the variable x(5) is connected to the variable x(2) by the edge. Then, by assigning the structural equation of the variable x(4) to the variable x(4) in Equation (6) and assigning the structural equation of the variable x(5) to the variable x(5), the following equation is obtained.

$$x ( 10 ) = f 10 ( f 7 ( x ( 3 ) , f 4 ( x ( 1 ) , x ( 2 ) ; ε ( 4 ) ) , f 5 ( x ( 2 ) ; ε ( 5 ) ) ; ε ( 7 ) ) , x ( 8 ) ; ε ( 10 ) ) \qquad ( 7 )$$

Next, by assigning the structural equation of the variable x(1) to the variable x(1) in Equation (7) and assigning the structural equation of the variable x(2) to the variable x(2), the following equation is obtained.

$$FY ( A , ε ) = x ( 10 ) = \text{} f \text{} 10 \text{} ( f 7 ( x ( 3 ) , \\ f 4 ( f 1 ( ε ( 1 ) ) , f 2 ( ε ( 2 ) ) ; ε ( 4 ) ) , f 5 ( f 2 ( ε ( 2 ) ) ; ε ( 5 ) ) ; ε ( 7 ) ) , x ( 8 ) ; ε ( 10 ) ) \qquad ( 8 )$$

Equation (8) represents the relationship between x(10), which is the control variable Y, and the variables x(3) and x(8), which are the intervention variables A.

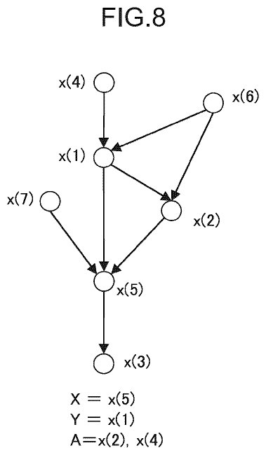

FIG. 8 illustrates an example of the second causal graph represented by the causal information 621. The causal graph in FIG. 8 includes the nodes representing the variables x(1) to x(7) in labor management. In this example, N=7.

The variable x(1) represents the overtime hours, the variable x(2) represents the salary, the variable x(3) represents the psychological reward, and the variable x(4) represents the comfort in the work environment. The variable x(5) represents the work-life balance, the variable x(6) represents the rank of the job position, and the variable x(7) represents the level of discretion. The structural equations of the variables x(1) to x(7) are expressed as follows.

$$x ( 1 ) = f 1 ( x ( 4 ) , x ( 6 ) ; ε ( 1 ) )$$

$$x ( 2 ) = f 2 ( x ( 1 ) , x ( 6 ) ; ε ( 2 ) )$$

$$x ( 3 ) = f 3 ( x ( 5 ) ; ε ( 3 ) )$$

$$x ( 4 ) = f 4 ( ε ( 4 ) )$$

$$x ( 5 ) = f 5 ( x ( 1 ) , x ( 2 ) , x ( 7 ) ; ε ( 5 ) )$$

$$x ( 6 ) = f 6 ( ε ( 6 ) )$$

$$x ( 7 ) = f 7 ( ε ( 7 ) )$$

The objective variable X in FIG. 8 is the variable x(5), and the intervention variable A is the variables x(2) and x(4). The structural equation of the variable x(5) is expressed by the following equation.

$$x ( 5 ) = f 5 ( x ( 1 ) , x ( 2 ) , x ( 7 ) ; ε ( 5 ) ) \qquad ( 9 )$$

The variable x(1) included in Equation (9) is connected to the variable x(4) by the edge. Then, by assigning the structural equation of the variable x(1) to the variable x(1) in Equation (9) and assigning the structural equation of the variable x(7) to the variable x(7), the following equation is obtained.

$$x ( 5 ) = f 5 ( f 1 ( x ( 4 ) , x ( 6 ) ; ε ( 1 ) ) , x ( 2 ) , f 7 ( ε ( 7 ) ) ; ε ( 5 ) ) \qquad ( 10 )$$

Next, by assigning the structural equation of the variable x(6) to the variable x(6) in Equation (10), the following equation is obtained.

$$FX ( A , ε ) = x ( 5 ) = f 5 ( f 1 ( x ( 4 ) , f 6 ( ε ( 6 ) ) ; ε ( 1 ) ) , x ( 2 ) , f 7 ( ε ( 7 ) ) ; ε ( 5 ) ) \qquad ( 11 )$$

Equation (11) represents the relationship between x(5), which is the objective variable X, and the variables x(2) and x(4), which are the intervention variables A.

The control variable Y in FIG. 8 is the variable x(1), and the intervention variable A is the variables x(3) and x(8). The structural equation of the variable x(1) is expressed by the following equation.

$$x ( 1 ) = f 1 ( x ( 4 ) , x ( 6 ) ; ε ( 1 ) ) \qquad ( 12 )$$

Assigning the structural equation of the variable x(6) to the variable x(6) in Equation (12), the following equation is obtained.

$$FY ( A , ε ) = x ( 1 ) = f 1 ( x ( 4 ) , f 6 ( ε ( 6 ) ) ; ε ( 1 ) ) \qquad ( 13 )$$

Equation (13) represents the relationship between x(1), which is the control variable Y, and the variable x(4), which is one of the intervention variables A.

The generation unit 613 generates function information 623 representing the function FX(A, ε) and the function FY(A, ε) and stores this information in the storage unit 616.

The optimization unit 614 generates a gain function u(α, ε) as follows by using the function FX(A, ε) and the function FY(A, ε) represented by the function information 623 and the target value 0 included in the input information 622.

$$u ( A , ε ) = FX ( A , ε ) - λ \sum d ( FY ( A , ε ) , 0 ) \qquad ( 14 )$$

λ represents an appropriate positive real number. d(FY(A, ε), 0) is a function representing the distance between FY(A, ε) and 0. d(FY(A, ε), 0) may be the absolute value of the difference between FY(A, ε) and 0. Σ represents the sum about one or more control variables Y.

The input A of the gain function u(A, ε) represents one or more intervention variables A that are included in FX(A, ε) or FY(A, ε) out of all the intervention variables A. The input ε of the gain function u(A, ε) represents one or more noises ε(i) included in FX(A, ε) or FY(A, ε) out of all the noises ε(i).

By executing the optimization process using the gain function u(A, ε) in Equation (14), it is possible to increase the value of the objective variable X and bring the value of the control variable Y closer to the target value 0. If the control to bring the value of the control variable Y closer to the target value 0 is not performed, −λΣd(FY(A, ε), 0) in Equation (14) is omitted.

Next, the optimization unit 614 generates an objective function T(A) as follows by using the gain function u(A, ε).

$$T ( A ) = \int u ( A , ε ) d ε \qquad ( 15 )$$

∫u(A, ε)dε represents the integral with respect to one or more noises ε(i) included in the gain function u(A, ε). Thus, T(A) represents the expected value of the gain function u(A, ε).

Next, the optimization unit 614 sets up the following optimization process using the objective function T(A) and the cost function C and the budget β included in the input information 622.

$$max T ( A ) such that \sum C ( A ) \leq β$$

The above optimization process represents the process of finding the value of the intervention variable A that maximizes the value of the objective function T(A) under the constraint condition ΣC(A)≤β. C(A) represents the cost calculated based on the cost function C from the value of any intervention variable A included in the objective function T(A). Σ represents the sum about all the intervention variables A included in the objective function T(A).

Next, the optimization unit 614 finds the value of each intervention variable A that maximizes the value of the objective function T(A) by executing the set optimization process, and transmits the value to the terminal device 501 via the communication unit 615. The obtained value of each intervention variable A is one example of the value of the intervention variable that improves the value of the objective function.

For example, in the example in FIG. 8, the value of the salary of the variable x(2) and the value of the comfort of the working environment of the variable x(4) are calculated and transmitted to the terminal device 501.

According to the action support system in FIG. 5, the causal information 621 is used to generate the function FX(A, ε), which represents the relationship between the objective variable X and the intervention variable A that the user can intervene, and the function FY(A, ε), which represents the relationship between the control variable Y and the intervention variable A. By executing the optimization process using the objective function T(A), which includes the functions FX(A, ε) and FY(A, ε), the value of the intervention variable A to achieve the objective can be effectively decided.

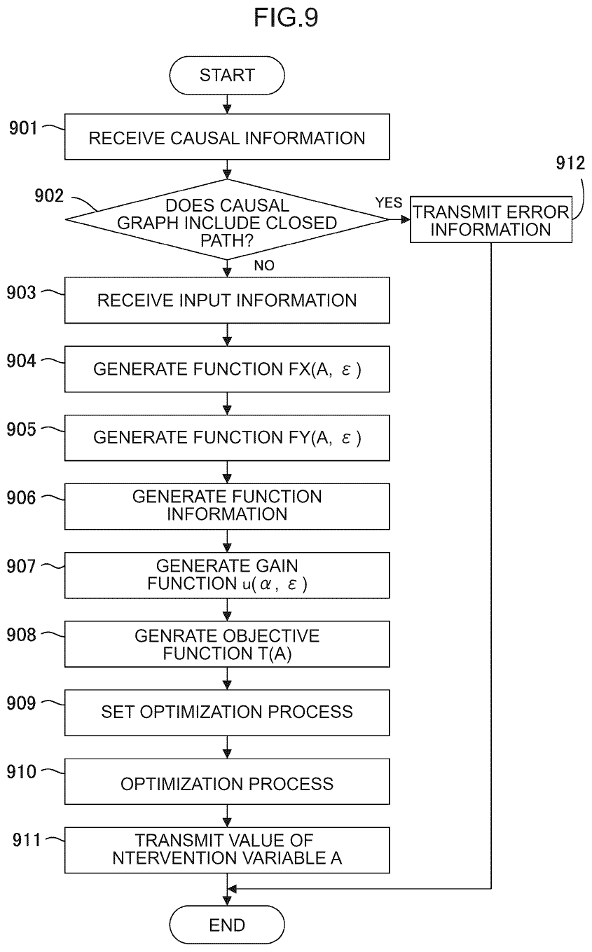

FIG. 9 is a flowchart illustrating an example of the action support process performed by the action support device 502 in FIG. 6. First, the acquisition unit 611 requests the terminal device 501 to transmit the causal information and receives the causal information 621 from the terminal device 501 via the communication unit 615 (step 901). Then, the verification unit 612 checks whether the causal graph represented by the causal information 621 includes a closed path (step 902).

If it is determined that the causal graph does not include a closed path (NO at step 902), the acquisition unit 611 requests the terminal device 501 to transmit the input information and receives the input information 622 from the terminal device 501 (step 903).

Next, the generation unit 613 uses the causal information 621 and the input information 622 to generate the function FX(A, ε) representing the objective variable X using the intervention variable A and the noise ε as inputs (step 904). Subsequently, the generation unit 613 uses the causal information 621 and the input information 622 to generate the function FY(A, ε) representing each control variable Y using the intervention variable A and the noise ε as inputs (step 905). Then, the generation unit 613 generates the function information 623 representing the functions FX(A, ε) and FY(A, ε) (step 906).

Next, the optimization unit 614 generates the gain function u(α, ε) using the functions FX(A, ε) and FY(A, ε) represented by the function information 623 and the target value 0 included in the input information 622 (step 907). The optimization unit 614 then generates the objective function T(A) using the gain function u(A, ε) (step 908).

Next, the optimization unit 614 sets the optimization process using the objective function T(A) and the cost function C and the budget β included in the input information 622 (step 909). Then, the optimization unit 614 finds the value of each intervention variable A that maximizes the value of the objective function T(A) by executing the set optimization process (step 910).

Next, the optimization unit 614 transmits the obtained value of each intervention variable A to the terminal device 501 via the communication unit 615 (step 911). The terminal device 501 displays the received value of the intervention variable on a screen as the action proposed by the action support device 502.

If it is determined that the causal graph includes a closed path (YES at step 902), the verification unit 612 transmits error information indicating that the execution of the optimization process is impossible to the terminal device 501 via the communication unit 615 (step 912). The terminal device 501 displays the received error information on the screen.

The configuration of the information processing device 301 in FIG. 3 is merely one example, and a part of the components may be omitted or changed according to the application or conditions of the information processing device 301.

The configuration of the action support system in FIG. 5 is merely one example, and a part of the components may be omitted or changed depending on the application or conditions of the action support system.

The configuration of the action support device 502 in FIG. 6 is merely one example, and a part of the components may be omitted or changed depending on the application or conditions of the action support system. For example, if the directed acyclicity of the causal graph represented by the causal information 621 is guaranteed, the verification unit 612 can be omitted.

The flowcharts in FIG. 4 and FIG. 9 are merely examples, and a part of the processes may be omitted or changed depending on the configuration or conditions of the information processing device 301 and the action support system. For example, if the directed acyclicity of the causal graph represented by the causal information 621 is guaranteed, steps 902 and 912 in FIG. 9 can be omitted.

The correlation expressed in FIG. 1 is merely one example; the correlation between the objective variable and the explanatory variable changes depending on the objective variable and the explanatory variable. The causal graphs in FIG. 2, FIG. 7, and FIG. 8 are merely examples; the causal graphs vary depending on the combination of variables.

Equations (1) to (15) are merely examples, and the action support device 502 may use other formulas for the action support process.

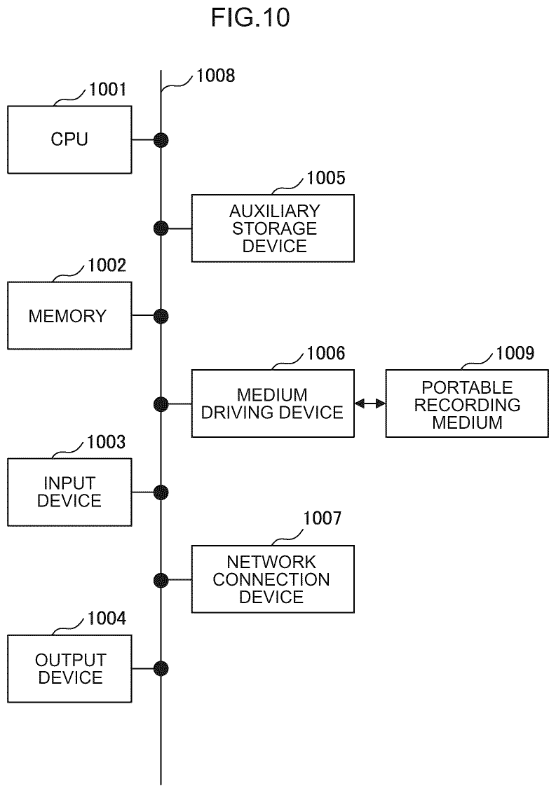

FIG. 10 illustrates a hardware configuration example of an information processing device used as the information processing device 301 in FIG. 3 and the action support device 502 in FIG. 6. The information processing device illustrated in FIG. 10 includes a central processing unit (CPU) 1001, a memory 1002, an input device 1003, an output device 1004, an auxiliary storage device 1005, a medium driving device 1006, and a network connection device 1007. These components are hardware and are connected to each other by a bus 1008.

The memory 1002 is a semiconductor memory, such as a read only memory (ROM) or a random access memory (RAM), and stores computer programs and data used for processing therein. The memory 1002 may operate as the storage unit 616 in FIG. 6.

The CPU 1001 (processor), for example, operates as the acquisition unit 311, the generation unit 312, and the decision unit 313 in FIG. 3 by executing computer programs using the memory 1002. The CPU 1001 also operates as the acquisition unit 611, the verification unit 612, the generation unit 613, and the optimization unit 614 in FIG. 6 by executing computer programs using the memory 1002.

The input device 1003 is, for example, a keyboard, a pointing device, or the like, and is used to input instructions or information from the user or operator. The output device 1004 is, for example, a display device, a printer, or the like, and is used to output inquiries or instructions to the user or operator and the results of the process. The output device 1004 may operate as the output unit 314 in FIG. 3. The result of the process may be the value of each intervention variable A.

The auxiliary storage device 1005 is, for example, a magnetic disk device, an optical disk device, a magneto-optical disk device, a tape device, or the like. The auxiliary storage device 1005 may be a hard disk drive or a solid state drive (SSD). The information processing device can store computer programs and data in the auxiliary storage device 1005, and load the computer programs and data into the memory 1002 for use.

The auxiliary storage device 1005 may operate as the storage unit 616 in FIG. 6.

The medium driving device 1006 drives a portable recording medium 1009 and accesses recorded contents therein. The portable recording medium 1009 is a memory device, a flexible disk, an optical disk, a magneto-optical disk, or the like. The portable recording medium 1009 may be a compact disk read only memory (CD-ROM), a digital versatile disk (DVD), a universal serial bus (USB) memory, or the like. The user or operator can store computer programs and data in the portable recording medium 1009 and load the computer programs and data into the memory 1002 for use.

Thus, the computer-readable recording medium that stores the computer programs and data used for processing therein is a physical (non-transitory) recording medium, such as the memory 1002, the auxiliary storage device 1005, or the portable recording medium 1009.

The network connection device 1007 is a communication device that is connected to the communication network 503 and performs data conversion associated with the communication. The information processing device can receive the computer programs and data from external devices via the network connection device 1007 and load the computer programs and data into the memory 1002 for use. The network connection device 1007 may operate as the output unit 314 in FIG. 3 or the communication unit 615 in FIG. 6.

It is unnecessary for the information processing device to include all the components in FIG. 10, and a part of the components may be omitted or changed depending on the application or conditions of the information processing device. For example, the input device 1003 and the output device 1004 can be omitted if the interface with the user or operator is not demanded. When the portable recording medium 1009 or the communication network is not used, the medium driving device 1006 or the network connection device 1007 can be omitted.

Although the embodiment of the disclosure and the advantages thereof have been described in detail, those skilled in the art will be able to make various changes, additions, and omissions without departing from the scope of the present invention as clearly set in the scope of claims.

According to one aspect, the value of the variable to be set out of the variables describing the problem can be effectively decided.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process comprising:
acquiring causal information representing a causal relationship among a plurality of variables, information representing a particular objective variable out of the variables, and information representing an intervention variable to be set out of the variables;
generating a particular function representing a relationship between the particular objective variable and the intervention variable, based on the causal information;
deciding, based on an objective function including the particular function, a value of the intervention variable that improves a value of the objective function; and
outputting the value of the intervention variable.

2. The non-transitory computer-readable recording medium according to claim 1, wherein the particular function represents the particular objective variable using the intervention variable and a noise.

3. The non-transitory computer-readable recording medium according to claim 2, wherein
the causal information includes a structural equation that generates a value of each of the variables,
a first variable, out of the variables, that is included in a particular structural equation that generates a value of the particular objective variable is connected to the intervention variable by one or a plurality of the causal relationships in the causal information, and
the generating includes assigning a first structural equation that generates the first variable to the first variable included in the particular structural equation.

4. The non-transitory computer-readable recording medium according to claim 2, wherein the process further includes:
acquiring information representing a control variable out of the variables and a target value of the control variable;
generating a control function representing a relationship between the control variable and the intervention variable, based on the causal information; and
generating the objective function using the particular function, the control function, and the target value.

5. The non-transitory computer-readable recording medium according to claim 4, wherein the control function represents the control variable using the intervention variable and the noise.

6. The non-transitory computer-readable recording medium according to claim 5, wherein
the causal information includes a structural equation that generates a value of each of the variables,
a first variable, out of the variables, that is included in a particular structural equation that generates a value of the particular objective variable is connected to the intervention variable by one or a plurality of the causal relationships in the causal information, and
a second variable, out of the variables, that is included in a control structural equation that generates a value of the control variable is connected to the intervention variable by one or the plurality of causal relationships in the causal information,
the generating includes assigning the first structural equation that generates the first variable to the first variable included in the particular structural equation, and
the generating includes assigning a second structural equation that generates the second variable to the second variable included in the control structural equation.

7. The non-transitory computer-readable recording medium according to claim 1, wherein
the causal information includes a causal graph representing the causal relationship among the variables, the process further includes determining whether the causal graph includes a closed path, and
when it is determined that the causal graph does not include the closed path, the generating includes generating the particular function, based on the causal information.

8. An information processing device comprising:
a processor configured to:
acquire causal information representing a causal relationship among a plurality of variables, information representing a particular objective variable out of the variables, and information representing an intervention variable to be set out of the variable;
generate a particular function representing a relationship between the particular objective variable and the intervention variable, based on the causal information;
decide, based on an objective function including the particular function, a value of the intervention variable that improves a value of the objective function; and
output the value of the intervention variable.

9. The information processing device according to claim 8, wherein the particular function represents the particular objective variable using the intervention variable and a noise.

10. The information processing device according to claim 9, wherein
the causal information includes a structural equation that generates a value of each of the variables,
a first variable, out of the variables, that is included in a particular structural equation that generates a value of the particular objective variable is connected to the intervention variable by one or a plurality of the causal relationships in the causal information, and
the processor is further configured to assign a first structural equation that generates the first variable to the first variable included in the particular structural equation.

11. The information processing device according to claim 9, wherein
the processor is further configured to:
acquire information representing a control variable out of the variables and a target value of the control variable,
generate a control function representing a relationship between the control variable and the intervention variable, based on the causal information, and
generate the objective function using the particular function, the control function, and the target value.

12. An information processing method comprising:
acquiring causal information representing a causal relationship among a plurality of variables, information representing a particular objective variable out of the variables, and information representing an intervention variable to be set out of the variables;
generating a particular function representing a relationship between the particular objective variable and the intervention variable, based on the causal information;
deciding, based on an objective function including the particular function, a value of the intervention variable that improves a value of the objective function; and
outputting the value of the intervention variable, by a processor.

13. The information processing method according to claim 12, wherein the particular function represents the particular objective variable using the intervention variable and a noise.

14. The information processing method according to claim 13, wherein
the causal information includes a structural equation that generates a value of each of the variables,
a first variable, out of the variables, that is included in a particular structural equation that generates a value of the particular objective variable is connected to the intervention variable by one or a plurality of the causal relationships in the causal information, and
the generating includes assigning a first structural equation that generates the first variable to the first variable included in the particular structural equation.

15. The information processing method according to claim 13, wherein the method further includes:
acquiring information representing a control variable out of the variables and a target value of the control variable;
generating a control function representing a relationship between the control variable and the intervention variable, based on the causal information; and
generating the objective function using the particular function, the control function, and the target value.
